(19) United States
(12) Patent Application Publication
(10) Pub. No.: US 2010/0170926 A1
(43) Pub. Date: Jul. 8, 2010

(54) Safety arrangement for bicycle apparatus carrier

(76) Inventor: Harald Richter, Engelbrand (DE)

Correspondence Address: KLAUS J. BACH, 4407 TWIN OAKS DRIVE, MURRYSVILLE, PA, 15668, US

(21) Appl. No.: 12/655,573

(22) Filed: Dec. 31, 2009

(30) Foreign Application Priority Data
Jan. 2, 2009 (DE) 20 2009 000 212.8

(51) Int. Cl. B62J 11/00

(52) U.S. Cl. 224/447

(57) ABSTRACT

In a safety arrangement for securely holding an apparatus supported on an apparatus holder which is mounted on a bicycle via a support socket and an apparatus holder disposed on the support socket, a mounting plate is provided which is fitted securely between the support socket and the apparatus holder and which is provided with a strap that extends from one side wall of the support plate around an apparatus disposed on the apparatus holder and is connected to a hook formed at the opposite side wall of the support plate for firmly holding the apparatus on the apparatus holder.

### BACKGROUND OF THE INVENTION

An apparatus carrier or support devices for mobile telephones, smart phones, mobile navigation systems or similar apparatus generally comprises a clamping jaws which are releasably mounted on a carrier socket by means of a rapid coupling structure. In a motor vehicle, the carrier socket is usually provided with a suction foot by way of which it can be attached to the windshield. In connection with a bicycle, it is usually provided with a clamping mechanism for mounting to the handle bar.

Usually the clamping jaw apparatus holder supports a mobile telephone or other apparatus safely by its clamping jaws which are provided with foamed rubber layers but since on a bicycle handlebar is subjected to greater vibrations than might be expected, it is advisable to provide safety means that will prevent unintentional release of the apparatus from the apparatus holder which might result in damage to, or destruction of, the apparatus.

It is therefore the object of the present invention to provide a simple device for firmly retaining an apparatus on an apparatus carrier even if the carrier is subjected to excessive vibrations.

### SUMMARY OF THE INVENTION

In a safety arrangement for securely holding an apparatus supported on an apparatus holder which is mounted on a bicycle via a support socket and an apparatus holder disposed on the support socket, a mounting plate is provided which is fitted securely between the support socket and the apparatus holder and which is provided with a strap that extends from one side wall of the support plate around an apparatus disposed on the apparatus holder and is connected to a hook formed at the opposite side wall of the support plate for firmly holding the apparatus on the apparatus holder.

The invention will become more readily apparent from the following description of an exemplary embodiment thereof with reference to the accompanying drawings.

### BRIEF DESCRIPTION OF THE DRAWINGS

FIG. 1 is a bottom view of the safety element according to the invention for use in connection with an apparatus carrier, and

FIGS. 2-10 show consecutive steps in the handling of the safety element upon installation between a carrier and a clamping jaw apparatus holder during insertion of the apparatus (for example cell phone) and securing the apparatus.

### DESCRIPTION OF A PARTICULAR EMBODIMENT

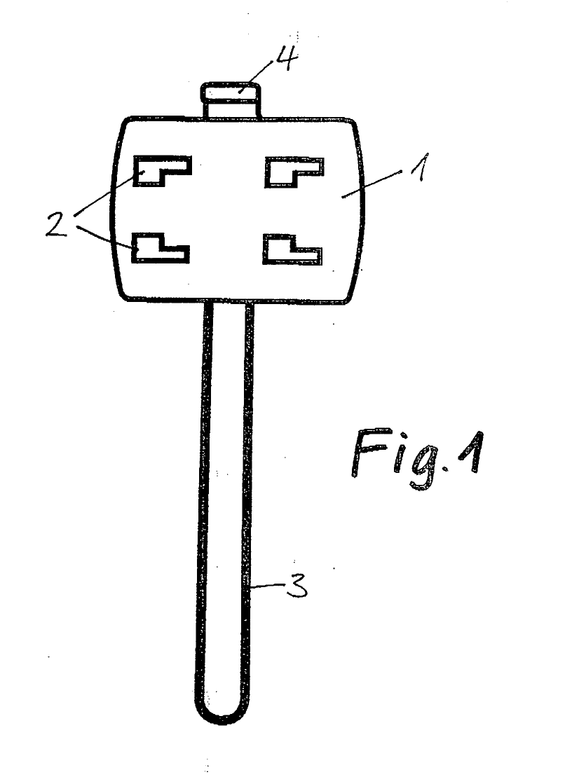

FIG. 1 is a bottom view of a safety element according to the invention consisting of a mounting plate 1, which, at its bottom side, is provided with an arrangement of four rapid coupling structures in the form of reception and engagement openings 2 and, at the top side, which is not-visible in FIG. 1, an arrangement of four rapid coupling elements in the form of hooks as shown for example in U.S. D545,826 for engagement in openings formed in the bottom of the clamping jaw apparatus holders, corresponding to the openings 2 shown in the mounting plate 1 of FIG. 1. In this way, the safety element with the mounting plate 1 can be interposed between a carrier plate and a clamping jaw holder and coupled to both. A rubber engagement strap 3 is attached to one side of the safety element mounting plate 1 and an engagement hook 4 is provided at the opposite side of the safety element mounting plate 1 for holding the rubber engagement strap 3 when extended around a clamping jaw holder with an apparatus disposed between the clamping jaws for securing the apparatus to the clamping jaw holder.

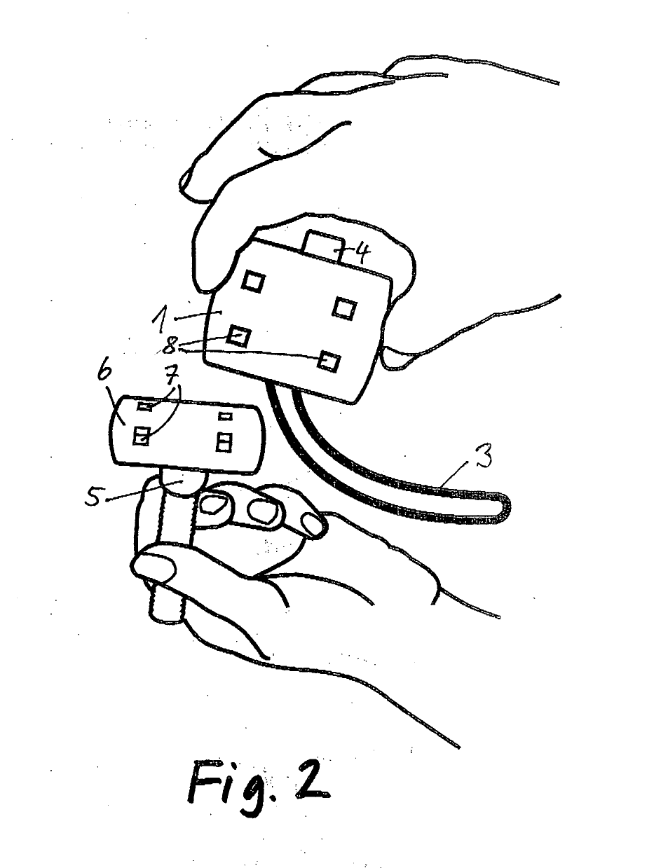

FIGS. 2-10 show the various steps involved in securing an apparatus to a carrier socket 5, which is shown only schematically and not attached to a bicycle handlebar but held by the hands of a user.

As shown in FIG. 2, the user holds the carrier socket 5 with its support plate 6 provided at its top side with engagement hooks 7 in one hand. The engagement hooks 7 are complementary to engagement openings 2 at the bottom side of the mounting plate 1 of the safety element, which is shown held by the other hand of the user. At the top side of the mounting plate 1, the engagement hooks 8 are visible in FIG. 2 which correspond to the engagement hooks 7 as shown on the support plate 6 of the carrier socket 5.

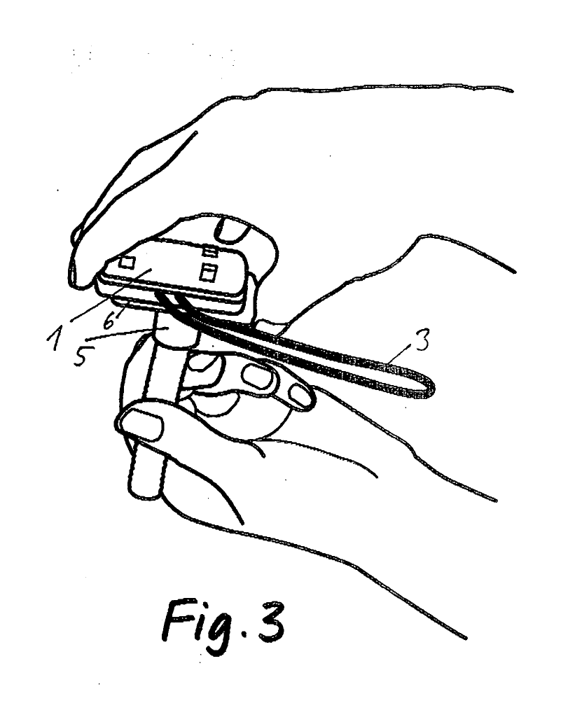

FIG. 3 shows the mounting plate 1 safety element being installed onto the support plate 6 of the carrier socket 5 and being locked thereto by the engagement of the hooks 7 in the engagement openings 2 in the bottom wall of the mounting plate 1.

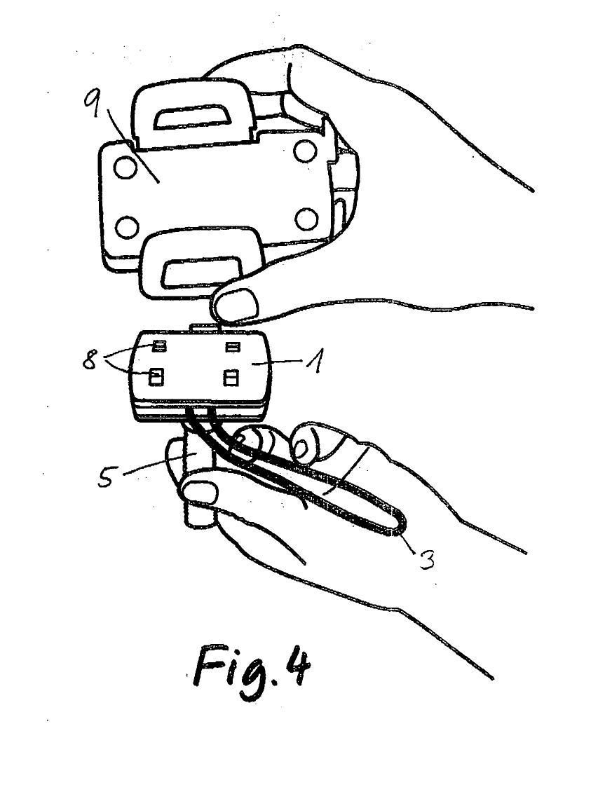

FIG. 4 shows the mounting plate 1 firmly installed on the support plate 6 of the carrier socket 5 and the clamping jaw apparatus holder 9 being installed on the mounting plate 1 of the safety element. The clamping jaw apparatus holder 9 has at its bottom side engagement opening formed the same way as the engagement openings 2 of the mounting plate 1. The clamping jaw apparatus holder 9 is shown in FIG. 4 being locked onto the top side of the mounting plate 1 of the safety element by way of the hooks 8 at the top side of the mounting plate 1 of the safety element.

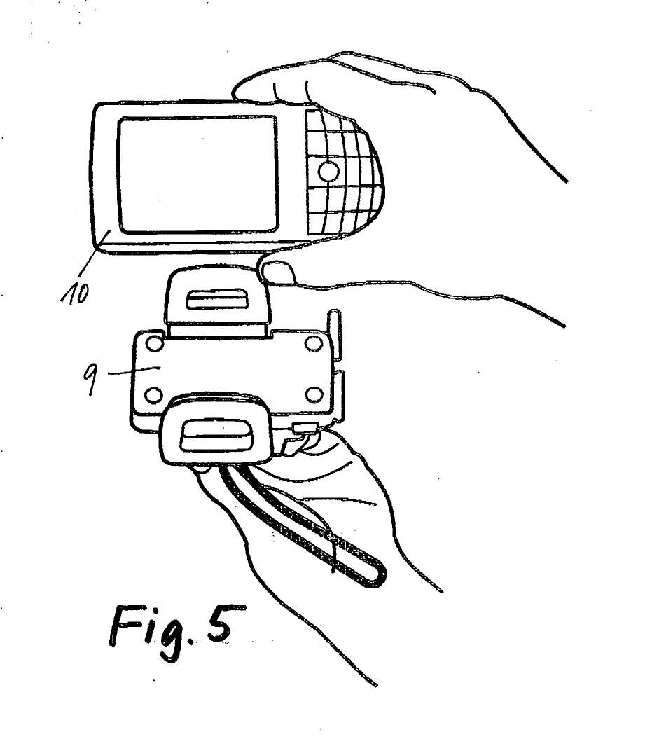

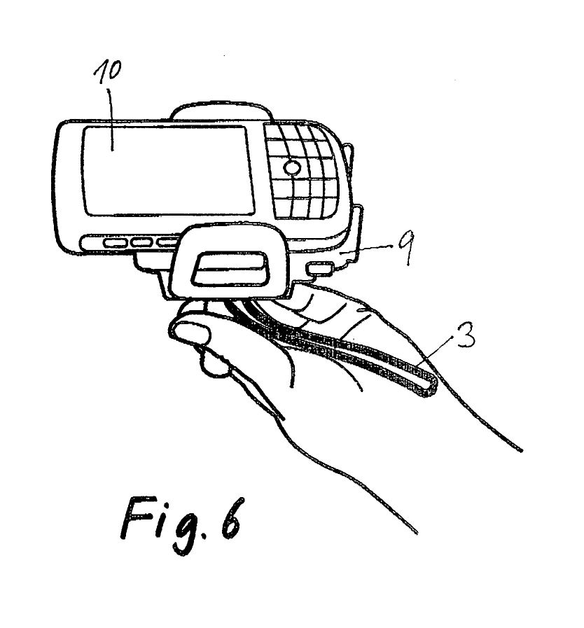

FIG. 5 shows the clamping jaw apparatus holder 9 firmly disposed on the mounting plate 1 of the safety element and an apparatus 10 for example a cell phone being disposed on the clamping jaw apparatus holder 9. FIG. 6 shows the apparatus 10 disposed on the clamping jaw apparatus holder 9.

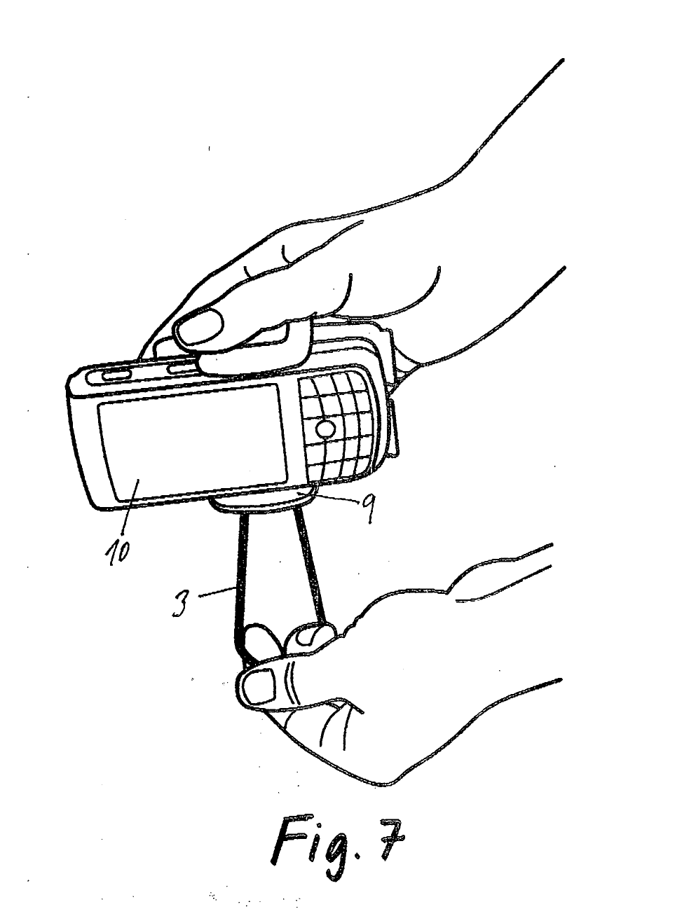

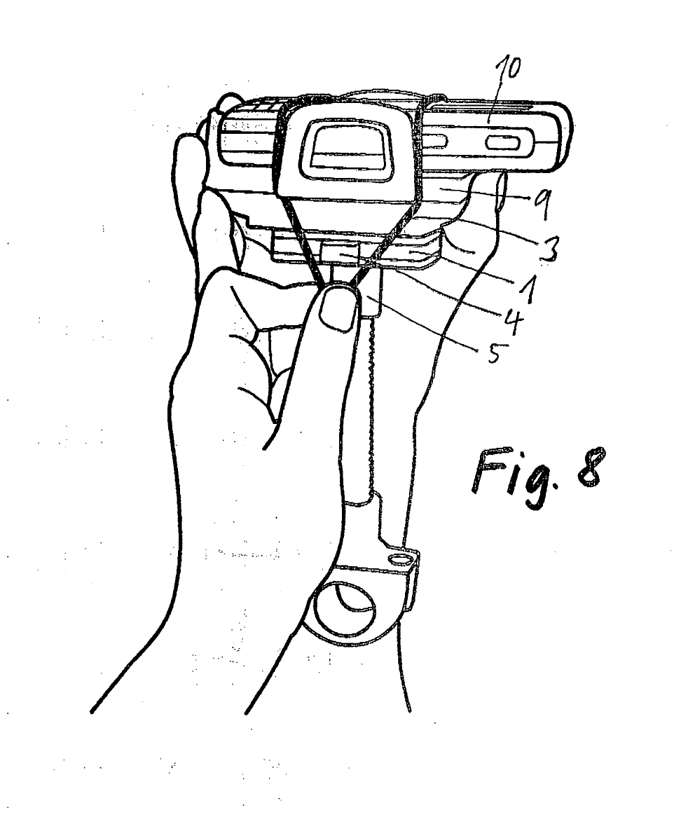

FIGS. 7 and 8 show the rubber strap 3 being extended around the apparatus 10 and the clamping jaw apparatus holder 9 and hooked to the retaining hook 4 which is arranged at the side opposite from where the rubber strap 3 is attached to the mounting plate 1 for firmly securing the apparatus 10 to the clamping jaw apparatus holder 9.

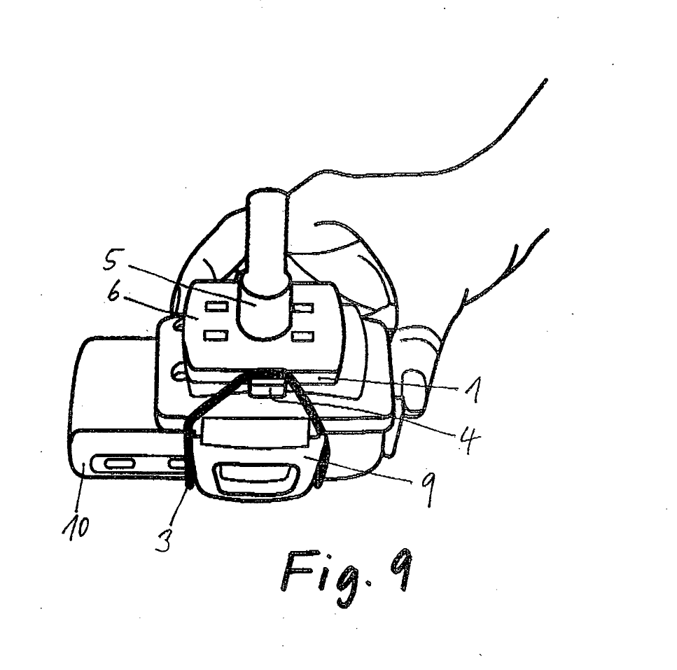

FIG. 9 shows the apparatus 10 in a secured state. The arrangement of the support socket 5, the mounting plate 1, the clamping jaw apparatus holder 9 and the apparatus 10 are shown in FIG. 9 in a bottom side view wherein the rubber engagement strap 3 can be seen hooked to the engagement hook 4.

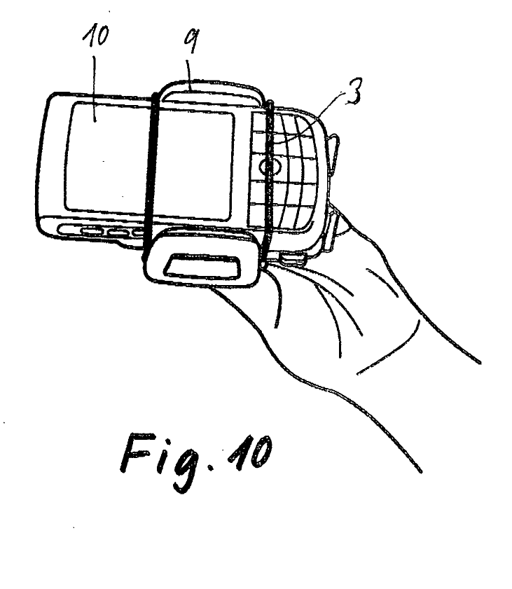

FIG. 10 finally shows the arrangement in a top side view in which the rubber engagement strap 3 is shown extending over and around the apparatus 10 for securing the apparatus 10 in place on the clamping jaw and apparatus holder 9.

What is claimed is:

1. A safety arrangement for securely holding apparatus such as navigation apparatus or cell phones on an apparatus holder for bicycles, comprising: a support socket (5) with a support plate (6) and an apparatus holder (9), and a mounting plate (1) installed between the support plate (6) and the apparatus holder (9), said mounting plate (1) having at one side thereof coupling elements complementary to coupling elements disposed on the support plate for attachment of the mounting plate (1) to the support plate (6) and, on its opposite side, coupling elements complementary to coupling elements on the apparatus holder (9) for attachment of the apparatus holder (9) to the mounting plate (1), said mounting plate (1) further being provided with an elastic engagement strap (3) connected to one side wall of the mounting plate (1) and an engagement hook (4) provided at the opposite side wall of the mounting plate (1), the elastic engagement strap (3) being extendable around an apparatus disposed on the apparatus holder (9) and attached to the engagement hook (4) for holding the apparatus in engagement with the apparatus holder (9).

2. A safety arrangement according to claim 1, wherein the coupling elements on the bottom wall of the mounting plate (1) are identical to the coupling elements on the bottom wall of the apparatus holder (9) and the coupling elements on the top wall of the mounting plate (1) are identical to those on the top wall of the support plate (6) to facilitate interposition of the mounting plate (1) between the support plate (6) and the apparatus holder (9).

3. A safety arrangement according to claim 1, wherein the resilient engagement strap (3) is a rubber band which is connected to one side wall of the support plate (1) and engageable with the hook (4) at the opposite side wall of the support plate (1).
